(19) United States
(12) Patent Application Publication
(10) Pub. No.: US 2007/0204240 A1
(43) Pub. Date: Aug. 30, 2007

(54) Display control and antenna positioning apparatus for display device

(76) Inventor: Melvin Bernard Diaz, La Palma, CA (US)

Correspondence Address: MURAMATSU & ASSOCIATES, Suite 310, 114 Pacifica, Irvine, CA, 92618, US

(21) Appl. No.: 11/640,617

(22) Filed: Dec. 18, 2006

Related U.S. Application Data
(60) Provisional application No. 60/754,247, filed on Dec. 27, 2005.

(51) Int. Cl. G06F 3/14; H04B 1/38

(52) U.S. Cl. 715/864; 455/90.3

(57) ABSTRACT

A display control and antenna positioning apparatus for a display device is capable of detecting positions of a navigation antenna that receives GPS signals. The navigation antenna is moveable such that a user is able to move it to an open position that is suitable for GPS signal reception, or to a closed position not suitable for GPS signal reception. When the navigation antenna is in the open position, the apparatus enables navigational functions while prohibiting non-navigational functions. When the navigation antenna is in the closed position, the apparatus disables navigational functions while allowing the non-navigational functions. A device mount prevents the display device from being received therein when the navigation antenna is in the closed position.

This application claims the benefit of U.S. Provisional Application No. 60/754,247 filed Dec. 27, 2005.

### FIELD OF THE INVENTION

This invention relates generally to a display control and antenna positioning apparatus for mobile media and navigation system, and more particularly, to a display control and antenna positioning apparatus that detects the position of the antenna to suitably change the operation of the mobile media or the navigation system by disabling or reducing navigation functions.

### BACKGROUND OF THE INVENTION

A navigation system performs travel guidance for enabling a user to easily and quickly reach the selected destination. A typical example is a vehicle navigation system where a vehicle is equipped with a navigation function to guide a driver to a destination through a calculated route. In recent years the use of both mobile media and navigation systems in a vehicle has become increasingly more common. Because of data storage requirements, such systems were initially somewhat bulky and required that the systems be permanently installed in the vehicle. However, more recently developed devices are sufficiently compact to allow them to be personally portable and be temporarily mounted within the vehicle. This gives the user the option to use the device both inside and outside of the vehicle.

In addition to decreasing their size, newer devices have begun to integrate various features, so that a single device can perform several different functions. For example, such a multi-function device may not only be able to display video images, but it may also be capable of displaying a navigational map. Further, such a multi-function device may be able to calculate an optimum route to a destination and perform a guidance operation along the calculated route.

As a result, certain devices offer the occupants of the vehicle the ability to watch movies or other video images while traveling. While this aspect of the devices provides the benefit of in-vehicle entertainment, it may also potentially cause the driver to be distracted from operating the vehicle. Clearly, such distraction can cause an accident to occur which may result in serious injury and/or death. However, when the portable device is used outside of the vehicle, the potential for driver distraction is removed and watching videos will typically be completely safe.

Further, with multi-function devices which are also capable of displaying navigation information, the driver needs to be able to view the displayed images while driving so as to follow the route guidance. This navigation information can include moving maps and directional symbols which are designed to aid in the operation of the vehicle. The navigation information may also include traffic incident information along the route to the destination which is also beneficial in the operation of the vehicle.

However, when the portable device is used outside of the vehicle, and is otherwise not moving, there tends to be less need, or no need, for the display of navigational information. With certain devices turning off, or reducing their operation loads, the operation of the navigation features can lower power usage and extend the battery life. Increased battery life is, of course, highly desirable when the portable device is operated away from a power source, such as that provided by a vehicle.

Therefore, a need exists for an apparatus which, while the device is used in a vehicle, will allow navigation information to be displayed, but at the same time not allow the display of distracting video images, such as movies. Further, a need exists for an apparatus that, when the device is used outside of a vehicle, will allow otherwise distracting images to be displayed, while at the same time stopping or reducing the operation of the navigation features to maximize battery life.

### SUMMARY OF THE INVENTION

It is, therefore, an object of the present invention to provide a display control and antenna positioning apparatus for a display device that can detect the position of an navigation antenna.

Moreover, it is another object of the present invention to change the operation of the display device based on the position of the antenna to effectively use the computer resources and provide suitable operation for a situation.

Still another object of the present invention is to provide a portable display device and a device mount where the device mount is fit to receive the portable display device such that the antenna of the portable display device is guaranteed to be in an operational condition when the portable display device is securely fixed to the cradle.

In at least one embodiment, the present invention includes a portable navigation and image display device, a cradle for receiving the display device, and a display control apparatus positioned between the display device and the cradle.

When the display device is separate or otherwise not received by the mount, the display device is capable of displaying either navigational or non-navigational images. The navigational images may include a moving map animation showing a constantly updated vehicle position. The non-navigational images may include the display of video images such as recorded movies or television shows, internet browsing, photographs, or other video images which are potentially distracting to a driver of a vehicle.

When the display device is received by the mount, the display control apparatus is capable of causing the display device to prevent the display of non-navigational images, while still allowing the display of navigational images. The display control apparatus is capable of causing the display device to stop or reduce the operation of the navigation functions to lower power usage. Further, the display control device is capable of requiring a navigation antenna on the display device to be positioned to facilitate the reception of a navigation signal.

In at least one embodiment the display control apparatus includes a movable navigation antenna, an antenna positioning sensor, and a stopper. The navigation antenna and the antenna positioning sensor are both positioned on the display device and the stopper is positioned on the device mount.

The navigation antenna is movable and is capable of being positioned in at least an operational position and a non-operational position. The antenna positioning sensor is capable of detecting the position of the antenna, in at least the operational and the non-operational positions. The antenna positioning sensor is further capable of communicating the antenna position to the operating system of the display device to control the operation of both the navigation system and the image display system.

In certain embodiments, with the antenna in an operational position, through the antenna sensor, the operating system will allow only the operation of the navigation system and with the antenna in the non-operational position the operating system will allow the operation of the non-navigation image display.

The stopper is positioned on the mount such that the antenna must be in its operational position when the display device is received in the mount. That is, the stopper prevents the reception of the display device into the mount when the antenna is in its non-operational position. As a result, the display control apparatus functions to only allow display of navigational images when the display device is positioned in the mount. This function assures that the driver of a vehicle will not be distracted by the non-navigational images during the operation of the display device within a vehicle.

According to the present invention, the display control and antenna positioning apparatus for the display device is capable of detecting positions of the navigation antenna that receives GPS signals. The navigation antenna is moveable such that a user is able to move it to the open position that is suitable for GPS signal reception, or to the closed position not suitable for the GPS signal reception. When the navigation antenna is in the open position, the apparatus enables navigational functions while prohibiting non-navigational functions. When the navigation antenna is in the closed position, the apparatus disables navigational functions while allowing the non-navigational functions. The device mount prevents the display device from being received therein when the navigation antenna of the display device is in the closed position.

### BRIEF DESCRIPTION OF THE DRAWINGS

FIG. 1A is a perspective view in part showing a back portion of the display device and a front portion of the device mount, and generally showing the display control apparatus in accordance with at least one embodiment of the present invention.

FIG. 1B is a perspective view in part showing a front portion of the display device and a front portion of the device mount, and generally showing the display control apparatus in accordance with at least one embodiment of the present invention.

FIG. 1C is a perspective view showing in part the display device and the device mount in a typical manner of installation in a vehicle in accordance with at least one embodiment of the present invention.

FIG. 1D is a side cross-sectional view of the display device and the device mount when the antenna of the display device is opened in accordance with at least one embodiment of the present invention.

FIG. 1E is a side cross-sectional view of the display device which is received by the device mount after the situation of FIG. 1D in accordance with at least one embodiment of the present invention.

FIG. 1F is a side cross-sectional view of the display device and the device mount when the antenna of the display device is closed in accordance with at least one embodiment of the present invention.

FIG. 1G is a side cross-sectional view of the display device which is incompletely received by the device mount after the situation of FIG. 1F in accordance with at least one embodiment of the present invention.

FIG. 2 is a side cross-sectional view of the display device and the mount in accordance with at least one embodiment of the present invention.

FIG. 3 is a schematic block diagram showing an example of electrical connection associated with a device function controller provided in the display device in accordance with at least one embodiment of the present invention.

FIG. 4 is a flow chart showing an example of operation steps of the display control apparatus in an embodiment of the present invention that alters the functions of the display device depending of the antenna condition.

### DETAILED DESCRIPTION OF THE PREFERRED EMBODIMENT

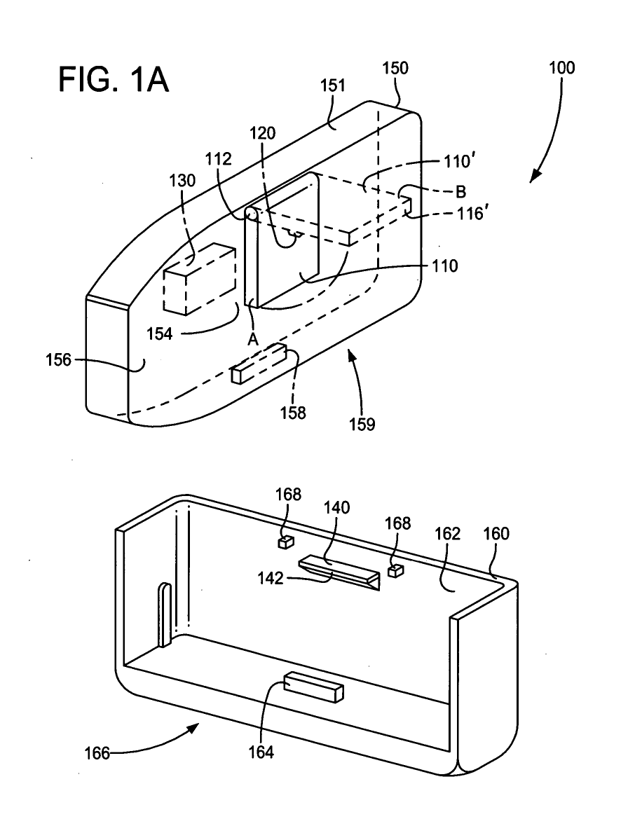

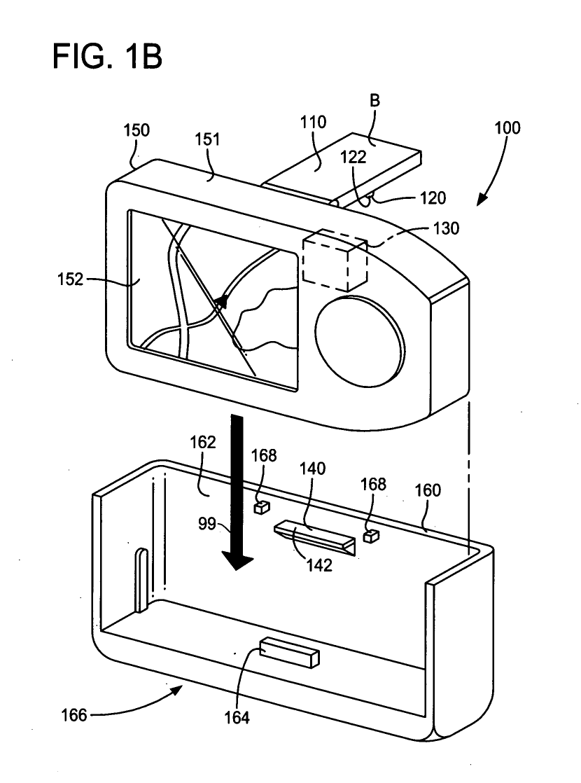

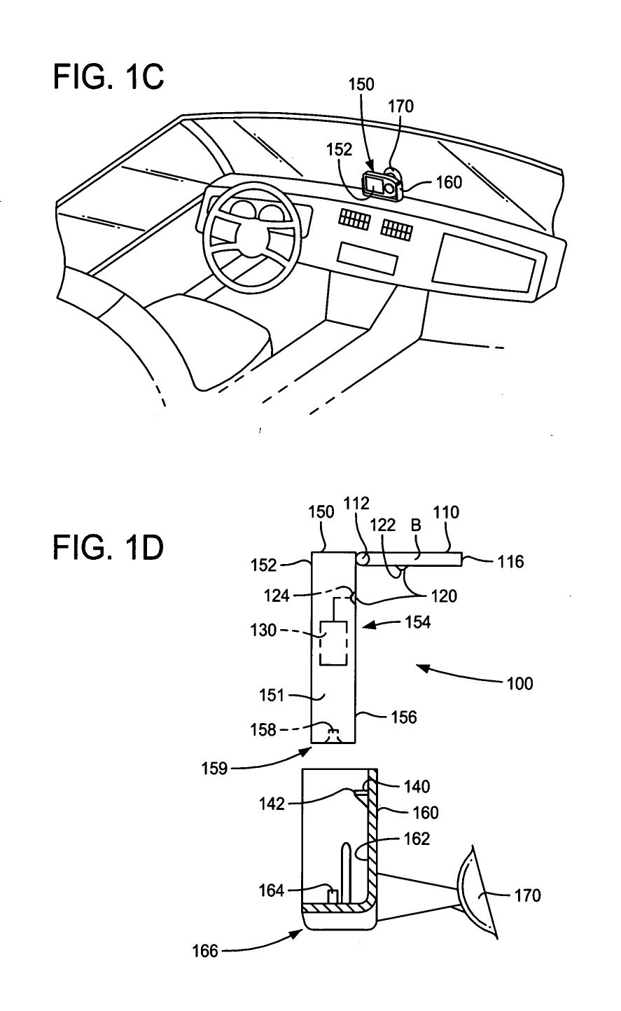

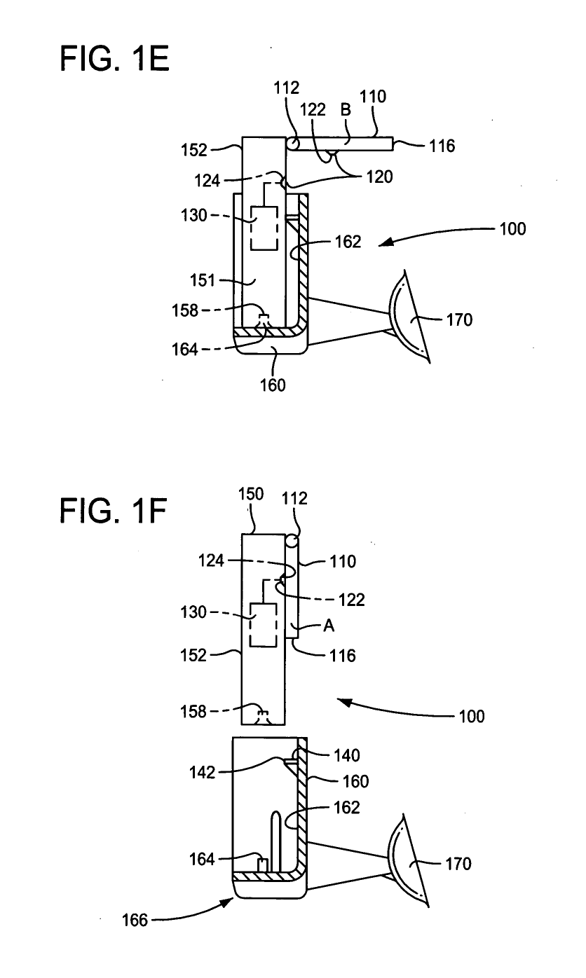

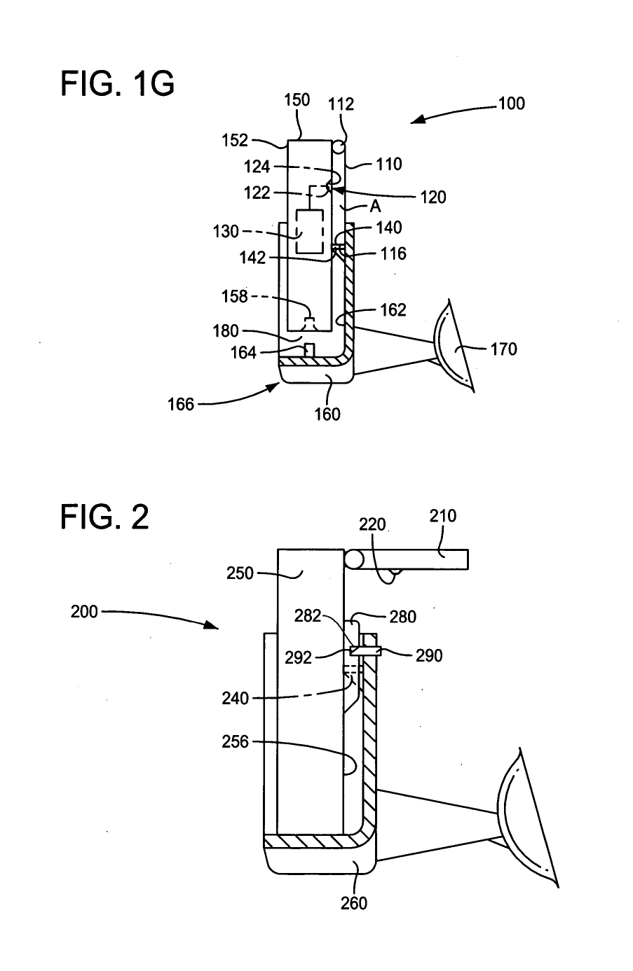

As shown in FIGS. 1A and 1B, in at least one embodiment, a display control apparatus 100 mainly comprises a display device 150 and a device mount or cradle 160. The display device 150 is a portable device that is capable of displaying an image on its screen and generating audible sounds as well as receiving signals by means of a GPS antenna as will be explained further in detail. The device mount (cradle) 160 is designed to receive the display device 150 and establish electrical connection therebetween. The display device 150 includes a navigation (GPS) antenna 110, an antenna positioning sensor 120, a device function controller 130 and a stopper 140.

The display device 150 can, depending on the embodiment, be any of a variety of devices. For example, the display device 150 can be a portable navigation and video display device, having a screen 152 which can display navigation or non-navigational related images, as shown in FIG. 1B. In this example, the screen 152 shows a map image for the navigation function, but movie or picture may be shown on the screen 152 as well.

Such navigational related images can include such items as maps, turn indicators or arrows, addresses, points of interests or POIs, various icons, and the like. Map images can include moving maps marking the location of the user of the device and updating the map as the user's position changes via a GPS or similar navigation system. These maps can be two-dimensional in a top down (plan) view, or three-dimensional, in a perspective view.

Non-navigational images can include recorded video, such as movies, TV programs, or music videos, internet contact (such as web pages, information, etc.) or other images such as menus, set-up and control screens. Non-navigational images can be stored in a memory storage unit of the display device, such as a hard drive, flash memory, or the like. The display device 150 may also function as a digital audio player such as an MP-3 player to reproduce audible sounds such as music, drama, foreign language study, etc.

As shown in FIGS. 1A and 1B, the display device 150 includes the navigation antenna 110, the antenna positioning sensor 120 and the device function controller 130. The display device 150 may also include a device electrical connector or interface 158 positioned at a bottom portion 159 of the display device 150. The electrical connector 158 functions to allow electronic signals, power, and the like to be transferred between the display device 150 and the device mount 160. Depending on the embodiment, the electrical connector 158 can have any of a variety of different embodiments, such as either a male or female plug or receptacle. In the example of FIGS. 1A and 1B, the connector 158 is a female receptacle.

Depending on the particular embodiment, the device mount (cradle) 160 can be any of a variety of configurations used to hold or secure the display device 150 in place. The device mount 160 allows for hand-free operations by positioning the display device 150 in a fixed manner such that it is easily viewed by the driver of the vehicle, as shown in FIG. 1C. In certain embodiments, the device mount 160 can be secured to the interior of the vehicle by means such as a suction cup 170, adhesive, fastener, or the like.

As shown in FIGS. 1A-1B and 1D, the device mount 160 is shaped and sized to receive at least a portion of the display device 150 in a sliding motion (downward sliding motion as shown by the arrow 99 in FIG. 1B). In the embodiments, the device mount 160 includes the stopper 140 on the inner wall. The device mount 160 may also include an electrical connector or interface 164 positioned at a bottom portion 166 thereof.

The electrical connector 164 is positioned to be capable of contacting or connecting with the device electrical connector 158. The electrical connector 164 functions to allow electronic signals, power, and the like to be transferred between the device mount 160 and the display device 150 via the device connector 158. Depending on the embodiment, the electrical connector 164 can have any of a variety of different embodiments, such as either a male or female plug or receptacle. In the example of FIGS. 1A-1B and 1D, the connector 164 is a male plug. As shown in FIG. 1E, with the display device 150 received by the device mount 160, the device electrical connector 158 and the electrical connector 164 are in contact, allowing electronic signals to be transmitted therebetween.

As shown in the embodiment of FIGS. 1A-1B and 1D-1E, the navigation (GPS) antenna 110 is a generally square shape, which is a typical shape of an antenna for receiving GPS signals. Of course, other embodiments can have different shapes and relative sizes for the antenna, depending on the types of signals and sensitivity of signals they are designed to receive. The navigation antenna 110 may be, as shown, positioned on a rear portion 154 of the display device 150.

The navigation antenna 110 is mounted to the display device 150 at a hinge 112, which allows the navigation antenna 110 to rotate from a closed or a navigation non-operational position A to an open or navigation operational position B as shown in FIG. 1A. As is shown, the antenna 110 of this embodiment can be positioned in any position between the marked open position B and the closed position A by rotating about the hinge 112.

In certain embodiments, the antenna 110 may be positioned to any of a number of positions further past the above noted open position B. In FIG. 1A, the navigation antenna 110 is shown along with the navigation antenna 110′ depicted in broken lines to show the navigation antenna in an open condition. However, the navigation antenna 110 may further be rotated upwardly or downwardly for better reception of the GPS signals depending on the angle of the display device 150 that is mounted in a vehicle, etc.

The closed position A has the navigation antenna 110 positioned along a back surface 156 of the display device 150. In this position, the navigation antenna 110 is generally out of the way of the user and allows for a more compact device for storage or transportation. When the navigation antenna 110 is in the closed position, the antenna will typically not be properly positioned for receiving signals from orbiting GPS satellites as the body 151 of the display device 150, buildings and other structures outside will block some, or all, of the GPS signals.

Also, in the closed position A, the navigation antenna 110 may not be positioned to avoid E.M.I and/or radiation problems. That is, the internal electronic components of the display device 150 may be capable of transmitting electromagnetic signals and/or other radiation. Such signals and radiation can interfere with the operation of the navigation antenna 110 due to the close proximity of the antenna 110 to these internal components when the antenna 110 is in the closed position A.

For these reasons, with the navigation antenna 110 in the closed position A, in the embodiments of the present invention, the navigation functions of the display device 150 are turned off, set into a standby mode, or otherwise reduced in their operational capacity. Having the navigation functions turned-off, or otherwise reduced, allows the display device 150 to reduce its power consumption and extend life of the battery. The standby mode also allows the additional processor resources for performing other functions such as video processing, etc.

The open position B for the navigation antenna 110 is shown in FIGS. 1A (shown in broken lines), 1B and 1D-1E. As shown in FIG. 1A-1B and 1D-1E, the navigation antenna 110 is positioned out and away from the body 151. This positioning provides a better position for the reception of satellite signals as the navigation antenna 110 is generally positioned so that the signals will be perpendicular, or generally perpendicular, to an upper surface of the antenna 110 without the body 151 being in the way of the satellite signals. The navigation antenna 110 also includes an end 116 positioned generally opposite to the hinge 112.

Since the device mount (cradle) 160 facilitates the use of the display device 150 during operations of a vehicle, and to allow the navigation functions to be employed during vehicle operations, the navigation antenna 110 needs to be in its open position B while the display device 150 is in the device mount 160, as shown in FIG. 1E. Clearly, if the navigation antenna 110 was in its closed position A while the display device 150 is in the device mount 160, then, reception of the satellite signals would be greatly impeded or obstructed by positioning the antenna 110 behind the structures of both the body 151 and the mount 160.

The display control apparatus 100 also includes the antenna positioning sensor 120, as shown in the embodiment of FIGS. 1A-1B and 1D-1G. The antenna position sensor 120 operates to inform the device function controller 130 of the current position of the navigation antenna 110. Then, as further described below, the device function controller 130 sets the operation of the navigation function in accordance with the position of the antenna 110.

The antenna position sensor 120 can be any of a variety of mechanisms depending on the particular embodiment of the display control apparatus 100. Some embodiments include contact switches, micro switches, proximity sensors, magnetic switches, inductance switches, optical indicators, pressure sensors, and the like. As shown, the antenna position sensor 120 includes a tab or pin 122 positioned on the navigation antenna 110 and a switch 124 positioned on the body 151 of the display device 150.

As shown in FIGS. 1D and 1F, as the navigation antenna 110 is moved to the closed position A from the open position B, the tab 122 projects into the body 151 and the switch 124 is activated. The activation of the switch 124 transmits a signal to the device function controller 130 indicating that the antenna is in its closed position. Depending on the condition under which the navigation system is operating, the device function controller 130 can control the range of functions of the display device 150.

More specifically, the device function controller 130 controls either the operation of the navigation functions, the non-navigation image display, both the navigation functions and the non-navigation image display, and/or other aspects of the operation of the display device 150. In certain embodiments, the device function controller 130 will turn-off, place in a stand-by mode or otherwise limit the operation of the GPS receiver when the controller 130 receives a signal or any other indication from the antenna position sensor 120 that the antenna 110 is in the closed position A. Further, in such embodiments, with a signal or other indication that the antenna 110 is in the open position B, the device function controller 130 will place the navigation functions in a full operating mode and prevent or turn-off the display of any non-navigation images or other potentially distracting images.

Referring to FIGS. 1A-1B and 1D-1G, the stopper 140 is positioned on the device mount 160 and operated to require the navigation antenna 110 to be in its open position B when the display device 150 is installed in the device mount 160. FIG. 1G shows that with the navigation antenna 110 in its closed position A, the stopper 140 comes into contact with the end 116 of the antenna 110 and prevents the display device 150 from being fully received by the mount 160. With the navigation antenna 110 in the open position B, as shown in FIG. 1E, the antenna 110 is rotated out of the way of the stopper 140, and the display device 150 is capable of being fully received by the device mount 160.

In the embodiments shown in FIGS. 1A-1B and 1D-1G, the stopper 140 is positioned on a back wall 162 of the device mount 160, such that the stopper 140 is located to contact the end of the closed antenna 110 as the display device 150 is slid into the device mount 160. In other embodiments of the invention, variations to the embodiments described above also possible. These variations can include the size and shape of the navigation antenna 110, the positioning of the antenna 110 on the display device 150, the shape and size of the device mount (cradle) 160, etc.

As a result, the particular size, shape and position of the stopper 140 may vary accordingly. For example, in certain embodiments, the stopper 140 may be one or more pins, tabs, clips or the like, which are located to contact the closed antenna 110. In other examples, the stopper 140 may be shaped or formed to receive only a portion of the navigation antenna 110 as to prevent a complete installation of the display device 150 into the device mount 160 with the antenna in the closed position A.

For the embodiments shown, the stopper 140 includes a contact surface 142, which is sized and positioned to contact the end 116 of the navigation antenna 110, when the antenna 110 is in, or generally in, its closed position A, as shown in FIG. 1G. As shown, because of the contact of the surface 142 and the end 116, the display device 150 is prevented from being completely received by the device mount 160. Thus, the display device 150 is unable to be in place and/or to make contact between the electrical connectors 158 and 164 for electrical communication.

Specifically, as the navigation antenna 110 and the stopper 140 contact each other a gap 180 is formed between the display device 150 and the device mount 160, such that the device 150 is not received by the mount 160. As such, the stopper 140 requires the navigation antenna 110 to be positioned in the opened position, for example the position B, for the display device 150 to be completely received by, and electrically connected to, the device mount 160.

As shown in FIGS. 1A-1B and 2, in the embodiments of the present invention, the device mount (cradle) 160 may also includes clips or tabs (clips 168 in FIGS. 1A and 1B). The clips or tabs 168 function to secure the position of the display device 150 upon its receipt into the device mount 160. Though not shown, the display device 150 may have corresponding notches or grooves in the back that snugly receives the clips 168.

The function of the clips or tabs 168 is explained with reference to the embodiment shown in the side view of FIG. 2 in which reference numerals are renumbered. As shown, the device mount 260 of the display control apparatus 200 has clips 290 that are sprung to be urged outward and include ramps 292 at the ends. The clips 290 and the ramps 292 at the ends allow the display device 250 to slide past the clips 290 as the display device 250 is positioned or slid into the device mount 260.

The clips 290 are received into openings 282 positioned on a structure 280, which extends out from the back 256 of the display device 250. The clips 290 can also include a retraction means (not shown), such as a levered button to move the clips 290 back out of the openings 282. Thus, by operating the retraction means, the display device 250 can be removed from the device mount 260 by a sliding motion (upward sliding motion as shown).

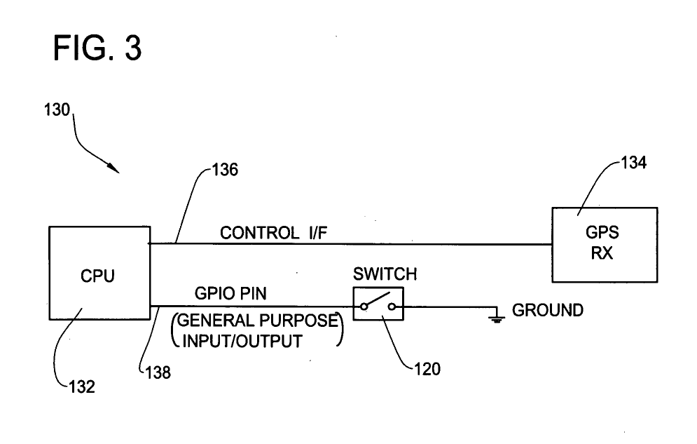

FIG. 3 is a schematic diagram showing an example of arrangement of the device function controller 130. As shown, the device function controller 130 includes a CPU 132, a GPS receiver 134, a control I/F 136, a GPIO (General Purpose Input/Output) pin 138, a switch (antenna positioning sensor) 120, and a ground. The switch 120 is connected between the GPIO pin 138 and the ground and the control IF 136 is positioned between the CPU 132 and the GPS receiver 134. In this manner, the CPU 132 can sense the position of the GPS antenna (not shown) and then send a corresponding command to the GPS receiver 134 to change its operating status (e.g. on, off, standby, etc.).

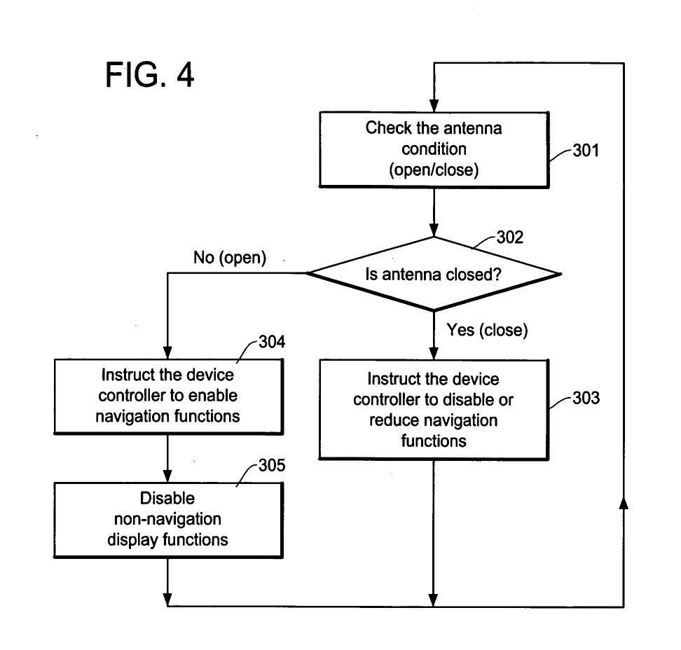

Referring to the flow chart in FIG. 4, the steps involved to change the operational functions of the display control apparatus 100 under the present invention are described. In the first step 301, the system will check whether the navigation antenna 110 is in the open condition or the closed condition. The detection of the antenna condition may be performed by the antenna positioning sensor (switch) 120 described above or any other means.

As noted above, the display control apparatus 100 will determine that the navigation functions are called for when the navigation antenna 110 is opened for receiving the GPS signals. On the other hand, when the navigation antenna 110 is closed, it will determine that the navigation functions are not necessary or not as important as in the condition when the antenna 110 is opened. Thus, the display control apparatus 100 determines whether the navigation antenna 110 is in the open condition or closed condition in step 302.

If the antenna is not closed (i.e., open), the display control apparatus 100 instructs the device function controller 130 to enable the navigation functions in step 304. Moreover, the display control apparatus 100 may also disable the non-navigation display functions such as playing movies or displaying images, in step 305, to avoid distraction to the user. Thus, the user can enjoy safe driving with the aid of the navigation functions without being distracted by non-navigation function.

If it is determined that the antenna is closed in step 302, the display control apparatus 100 will instruct the device controller to disable or reduce the navigation functions in step 303. For example, the display control apparatus 100 stops the communication by the navigation antenna 114 altogether, or reduce the frequency of the communication. This allows more computational resources to be used for non-navigational functions and saving the power source such as battery.

As has been described above, according to the present invention, the display control and antenna positioning apparatus for the display device is capable of detecting positions of the navigation antenna that receives GPS signals. The navigation antenna is moveable such that a user is able to move it to the open position that is suitable for GPS signal reception, or to the closed position not suitable for the GPS signal reception. When the navigation antenna is in the open position, the apparatus enables navigational functions while prohibiting non-navigational functions. When the navigation antenna is in the closed position, the apparatus disables navigational functions while allowing the non-navigational functions. The device mount prevents the display device from being received therein when the navigation antenna of the display device is in the closed position.

Although the invention is described herein with reference to the preferred embodiment, one skilled in the art will readily appreciate that various modifications and variations may be made without departing from the spirit and scope of the present invention. Such modifications and variations are considered to be within the purview and scope of the appended claims and their equivalents.

What is claimed is:

1. A display apparatus for displaying a map or video image, comprising;
a navigation antenna having an operational position and a non-operational position;
an antenna positioning sensor for determining the position of the navigation antenna in either the operational position or the non-operational position;
a device function controller for controlling an operation of the display apparatus;
wherein the device function controller is in communication with the antenna positioning sensor such that the device function controller changes functions of the display apparatus depending on the operation position or the non-operational position of the navigation antenna.

2. A display apparatus according to claim 1, wherein the navigation antenna is rotatably attached to the display apparatus such that navigation antenna is capable of changing its angle to receive signals.

3. A display apparatus according to claim 2, wherein the navigation antenna and a surface portion of the display apparatus make contact in the non-operational position of the navigation antenna whereas the navigation antenna and the surface portion of the display apparatus are away from one another in the non-operational position of the navigation antenna.

4. A display apparatus according to claim 3, wherein the antenna positioning sensor includes a pin and a switch where the pin presses against the switch provided on the surface of the display apparatus when the navigation antenna is in the non-operational position to signal that the antenna is in the non-operational position whereas the pin of the navigation antenna and the switch provided do not make contact in the non-operational position of the navigation antenna to signal that the navigation antenna is in the non-operational position.

5. A display apparatus according to claim 1, wherein the device function controller disables or reduces navigational functions when it detects that the navigation antenna is in the non-operational position and enables navigational function when it detects that the navigation antenna is in the operational position.

6. A display apparatus according to claim 1, wherein the device function controller comprises a CPU that connects to a GPS receiver such as to control the operation of the GPS receiver, and the CPU further connected to a switch that changes the condition based on the operational or non-operational position of the navigation antenna.

7. A display control apparatus for controlling functions of a display device, comprising;
a portable display device having a navigation antenna which is movable between an operational position and a non-operational position; an antenna positioning sensor for determining the position of the navigation antenna in either the operational position or the non-operational position; and a device function controller for controlling an operation of the portable display device; and
a device mount that receives the portable display device and established electrical communication with the portable display device;
wherein the device function controller is in communication with the antenna positioning sensor such that the device function controller changes functions of the display apparatus depending on the operation position or the non-operational position of the navigation antenna.

8. A display control apparatus according to claim 7, wherein the device mount has a stopper that is configured and positioned to prevent the portable display device from receiving therein when the navigation antenna of the portable display device is in the non-operational position.

9. A display control apparatus according to claim 7, wherein the navigation antenna is rotatably attached to the portable display device such that navigation antenna is capable of changing its angle to receive signals.

10. A display control apparatus according to claim 7, wherein the navigation antenna and a surface portion of the portable display device make contact in the non-operational position of the navigation antenna whereas the navigation antenna and the surface portion of the portable display device are away from one another in the non-operational position of the navigation antenna.

11. A display control apparatus according to claim 10, wherein the antenna positioning sensor includes a pin and a switch where the pin presses against the switch provided on the surface of the portable display device when the navigation antenna is in the non-operational position to signal that the antenna is in the non-operational position whereas the pin of the navigation antenna and the switch provided do not make contact in the non-operational position of the navigation antenna to signal that the navigation antenna is in the non-operational position.

12. A display control apparatus according to claim 7, wherein the device function controller disables or reduces navigational functions of the portable display device when it detects that the navigation antenna is in the non-operational position and enables or increases the navigational functions when it detects that the navigation antenna is in the operational position.

13. A display control apparatus according to claim 7, wherein the display mount includes means for fitting the portable display device with the device mount the device mount fully receives the portable display device so as to securely hold the portable display device.

14. A display control apparatus according to claim 13, wherein the means for fitting the portable display device with the device mount is configured by a clip provided to the device mount and a notch provided to the portable display device such that the clip fits to the notch when the device mount fully receives the portable display device so as to securely hold the portable display device.

15. A method of controlling functionality of a display device, comprising the following steps of:
determining a navigation position of the display device;
enabling or increasing navigation functions of the display device if the antenna position is in an operational position; and
disabling or reducing the navigation functions of the display device if the antenna position is in a non-operational position.

16. A method of controlling functionality according to claim 15, further comprising a step of disabling non-navigational functions of the display device when the navigation antenna is determined to be in the non-operational position.

17. A method of controlling functionality according to claim 15, further comprising a step of preventing the display device from receiving in a device mount when it is determined that the navigation antenna is in the non-operational position.
